(19) United States
(12) Patent Application Publication
(10) Pub. No.: US 2026/0046028 A1
(43) Pub. Date: Feb. 12, 2026

(54) SIGNALING BEACON USING A VARIABLE PRESSURE ACTIVATED POROUS VOLUME INFRARED FREQUENCY EMITTER

(71) Applicant: The United States of America, as represented by the Secretary of the Navy, Crane, IN (US)

(72) Inventors: Aaron B. Cole, Bloomington, IN (US); Jules E. Pienkos, Bloomington, IN (US)

(73) Assignee: The United States of America, as represented by the Secretary of the Navy, Arlington, VA (US)

(21) Appl. No.: 19/361,842

(22) Filed: Oct. 17, 2025

Related U.S. Application Data
(63) Continuation-in-part of application No. 16/184,976, filed on Nov. 8, 2018, now abandoned.
(60) Provisional application No. 62/583,450, filed on Nov. 8, 2017.

(51) Int. Cl. H04B 10/50; F04B 23/02; F04B 49/06; F04B 49/22; G02B 13/14; G05D 16/00; G08B 1/06

(52) U.S. Cl. CPC H04B 10/50; F04B 23/02; F04B 49/065; F04B 49/22; G02B 13/14; G05D 16/024; G08B 1/06

(57) ABSTRACT

Disclosed is a signaling beacon that includes an infrared or thermal energy emission system using fluid such as water for use in infrared signaling without the need for more complicated electronic systems. The beacon includes a pump coupled to a porous media emission structure that selectively allows fluid in and out of the. The apparatus features a porous structure that generate one or more fluid structures such as droplets or other fluid shapes that effectively increase or decrease fluid surface area on the fluid emission structure and thereby increase or decrease energy emissions in relation to the fluid emission structure. The control system can selectively modulate pressure/fluid transfer via the fluid pump to alter energy emission according to a modulation pattern that can be detected at a distance and recognized as a known signal.

### CROSS-REFERENCE TO RELATED APPLICATIONS

This application is a continuation-part-application of pending U.S. patent application Ser. No. 16/184,976, filed on Nov. 8, 2018, and entitled “A COMMUNICATION OR SIGNALING SYSTEM THAT INCLUDES A VARIABLE PRESSURE ACTIVATED POROUS VOLUME EMITTER ALONG WITH RELATED METHODS,”, which in turn claims priority to and the benefit of U.S. Provisional Patent Application Ser. No. 62/583,450, filed on Nov. 8, 2017, entitled “VARIABLE PRESSURE ACTIVATED POROUS VOLUME EMITTER”, the disclosures of which are both expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Cases 200,508 and 200,007) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The field of the present disclosure relates generally to communication or signaling systems such as signaling beacons that include processes and/or devices leveraging various physical principles including using thermal or electromagnetic energy radiation as a function of surface area. More particularly, the present disclosure relates to signaling beacons that utilize a variable pressure activated porous volume that emits infrared energy (e.g., infrared thermal energy) through the variation or manipulation of a liquid at a surface area on a volume that is visible for sensing by an observer device (e.g., infrared sensor) to thereby increase or decrease the amount of thermal energy transfer that is sensed remotely.

### BACKGROUND

Signaling devices and/or systems such as signaling beacons may utilize transmission of infrared fluence (i.e., the infrared radiant energy received by a surface per unit area) and/or infrared radiance (i.e., radiant energy emitted, reflected, transmitted or received by a given surface) to signal to a receiver or observing device configured to detect transmitted infrared radiant energy. Such signaling is beneficial in a wide variety of applications such as aircraft avoidance, personnel search and rescue in maritime, arboreal, and mountainous regions, and automobile collision avoidance. Existing known technologies utilize activated solid structures or excited fluids to alter the state of a source to achieve infrared emissions for imaging, illumination, or absorption. Additionally, plasmas may be used as a source but are energy inefficient for many applications. Accordingly, there is a need for a signaling device such as a signaling beacon utilizing infrared fluence/radiance that is both energy efficient, has a smaller form factor (e.g., portable), and does not require complicated, high-cost hardware.

### SUMMARY

Various embodiments of the present disclosure may be applicable to several commercial applications where infrared fluence or radiance at or to a receiver or observing device is beneficial such as with aircraft avoidance, personnel search and rescue in maritime, arboreal, and mountainous regions, and automobile collision avoidance. Various embodiments of the present disclosure may include apparatus and methods that enable a substantial reduction in power usage for thermal energy signaling, as well as providing a capacity to modulate the energy emission or absorption in a variety of ways that provide significant advantages over the known prior art.

Embodiments of the present disclosure improve over existing solutions or technology by utilizing a modulated or controlled pressure driven flow of a fluid to alter surface area conditions at a surface (e.g., a porous surface with a plurality of apertures), which in turn engenders a change in the thermal energy of the fluid (i.e., a change in the radiance and/or emissivity of thermal or infrared energy). This change in thermal energy at the surface due to altered fluid conditions is visible to a receiver for engendering systems or apparatus for communication or signaling. Different embodiments of this disclosure may allow for other advantages over current technologies such as enhancing sensing abilities over a greater range than typical visualization allows, developing low cost sensing equipment, creating a smaller form factor over conventional technology, permitting a high emissivity versus device two dimensional projection of three-dimensions (3D) volume, allowing for flexible design capabilities (i.e., sweeping specific spectral ranges), creating a manual emissivity by a user in the case of a power failure, and providing the capability for modular plug and play type systems for signaling.

Methods, as well as exemplary energy emission apparatus or systems, are provided that may include a control system, a fluid reservoir, fluid transfer structures, a fluid pumping system, a fluid emission structure, an enclosure extending away from the fluid emission structure, a fluid recovery system, and a lens structure configured to allow the passage or transmission of radiant (e.g., infrared) energy through the lens structure. The exemplary fluid emission structure may include a porous structure and/or fluid transfer structure(s) with a number of fluid emission sections that generate one or more fluid changes or structures such as droplets or other fluid shapes that may increase or decrease the fluid surface area on the fluid emission structure and thereby increase or decrease energy emissions or absorption on or in relation to the fluid emission structure. The exemplary control system may include fluid modulation control devices, control instructions or logic, and/or other ancillary control sections that serve to selectively modulate pressure generated by the fluid pumping system into the fluid transfer structures. Exemplary fluid transfer structures pass fluid to the fluid emission structure.

In further aspects, a signaling beacon is disclosed that includes a porous media unit configured to allow a fluid to flow there through, the porous media unit including a porous medium configured to allow fluid to flow there through according to at least one fluid flow characteristic. The porous media unit includes a first surface disposed on a first side of the porous medium, the first surface including a plurality of apertures therein that are configured to allow at least a portion of the fluid within the porous media to be selectively exuded onto the first surface or withdrawn from the first surface through the plurality of apertures, and a second surface disposed on a second side of the porous medium opposite the first surface of the porous medium and configured to selectively receive the fluid input to the porous medium or to receive the fluid withdrawn out of the porous medium. Additionally, the beacon includes a fluid transmission system including a fluid pump configured to selectively cause the fluid to be pumped into or drawn out of the porous medium via the second surface, a fluid pressure regulation unit in fluid communication with and disposed between the fluid pump and the second surface, the fluid pressure regulation unit configured to regulate at least one or more of fluid flow, fluid pressure gradients, and volume of the fluid into or out of the porous medium. The fluid transmission system also includes at least one processor configured to control operation of at least the fluid pump according to a predetermined sequence to cause the fluid to be selectively exuded onto or withdrawn from the first surface according to a predetermined modulation pattern. Additionally, at least a portion of the fluid within the porous media is to be selectively exuded onto the first surface or withdrawn from the first surface through the plurality of apertures under control of the fluid transmission system.

### BRIEF DESCRIPTION OF THE DRAWINGS

FIG. 1A shows a simplified system architecture of a signal beacon according to certain aspects of the presently disclosure;

FIG. 1B illustrates an exemplary side view of one embodiment of a variable pressure activated porous volume emitter apparatus according to certain aspects to the present disclosure;

FIG. 2 shows an exemplary view of one embodiment of an exemplary variable pressure activated porous volume emitter according to certain aspects of the presently disclosure;

FIG. 3 shows an alternate exemplary view of one embodiment of an exemplary variable pressure activated porous volume emitter according to certain aspects of the present disclosure;

FIG. 4 shows another exemplary embodiment of an exemplary variable pressure activated porous emitter that has valves (or optionally separate pumps) that are operated to generate spatially independent flows through different flow paths allowing for localized fluid interaction or different patterns on a given emissive surface according to certain aspects of the present disclosure;

FIG. 5 shows three exemplary pressure curves of an exemplary fluid generated within or from an exemplary emittance space of an exemplary embodiment showing an exemplary modulation of pressure associated with a desired communication or signaling modulation according to certain aspects of the present disclosure;

FIG. 6 shows another three exemplary pressure curves of pressure modulation of exemplary fluid(s) in an exemplary emittance space in relation to an exemplary porous volume emitter wherein these exemplary altered fluid states in an exemplary emittance space may enable or provide for controllable view factors according to certain aspects of the present disclosure; and

FIGS. 7A and 7B show a method of operation of a beacon system according to certain aspects of the present disclosure.

### DETAILED DESCRIPTION

Embodiments of the disclosure described herein are not intended to be exhaustive or to limit the disclosure to precise forms disclosed. Rather, the embodiments selected for description have been chosen to enable one skilled in the art to practice the disclosure.

Generally, one or more embodiments of the presently disclosed invention serve as a beacon or a thermal emission source that serves as a beacon. In aspects, the presently disclosed beacon may employ the modification or adjustment of an apparent rate of energy (e.g., heat or infrared) exchange or emission from the beacon by adjusting or altering a surface area of a fluid with a given temperature via the use of droplet sprays or emission of the fluid from a surface or nozzle(s), etc., which is a part of the beacon or energy emission source. In at least some aspects, porous media and/or nozzle structures within the apparatus may be used in combination with a variety of pressure drop methods to alter flows through a droplet creation device, which changes the surface area of the fluid when it expands and/or erupts from a surface into an emittance space within the beacon or energy emission source (e.g., a space between a surface or porous media that exudes droplets or fluid and a lens structure).

It is noted here that the flow of fluids through porous media has been studied extensively. For example, the flow of gases or liquids through porous rock, cork, felt, fritted glass, and packed columns of granular solids has been investigated. Furthermore, for the presently disclosed beacons and methods of operating such beacons, the flow of fluids through foamed materials (e.g., Styrofoam) with interconnecting cells may be utilized. Other exemplary porous media that may be used include rubber and urethane foams, which typically have a regular structure. An additional feature of soft foams is that they may be readily deformed with corresponding changes in their permeability.

Exemplary droplet sprays can include fluid flows that begin as a jet or slug of liquid and are expanded or erupted into a relatively smaller localized mass flow in which the density is greatly decreased. A porous media structure may be implemented by any structure through which either deterministic or non-deterministic fluid flow occurs from one region of a structure at high pressure and which erupts into droplets from a different region experiencing lower pressure. A deterministic flow can include a flow path of known entry and exit points predetermined by the geometry. Deterministic flow path examples can be analogous to simple tubes/pipes. An exemplary non-deterministic flow can be brought about by chaotically transferring a fluid through a variety of or any combination of paths between entry and exit points. Nozzle based structures can be based upon a device having a variable cross-sectional area through which a fluid undergoes a pressure drop to create droplets or droplet spray.

Exemplary pressure drop methods can utilize high pressures at entrance points and expand into an unbound region at the exit point. Exemplary droplet creation devices may be further expanded to refer to any, all of, or a combination of the porous media, nozzle, and alternate methods. A perceived or exemplary surface area of the exemplary fluid can include an observable volumetric space occupied by droplets in an exemplary emittance space upon expansion from a surface of an exemplary droplet creation device.

Exemplary expansion, as described in relation to at least one embodiment, can refer to a decrease in fluid density by a device that has increasing cross sectional area through the flow path into the emittance space. Eruption can be defined as an ejection of droplets from a fine structure, such as a porous media, mesh, screen, etc. in which the flow is pressurized at the plenum or inlet(s) of the media, mesh, screen, etc., and a lower pressure volume at the exit or the emittance space. An emittance space defined by a space between a lens and an emissive surface from an exemplary porous media can be maintained at a lower relative pressure volume where inlet and outlet liquid mass is controlled such that droplets or droplet spray(s) are periodically modulated to expand or erupt into a volume where apparent emissivity is optimized.

An exemplary surface area can be significant to an emissive surface. An exemplary perceived surface area can be created by the formation and removal of the localized fluid droplets creates an emittance. By designing a controllable, continuously altering perceived surface area state, an exemplary device provides a variety of novel functions or capabilities.

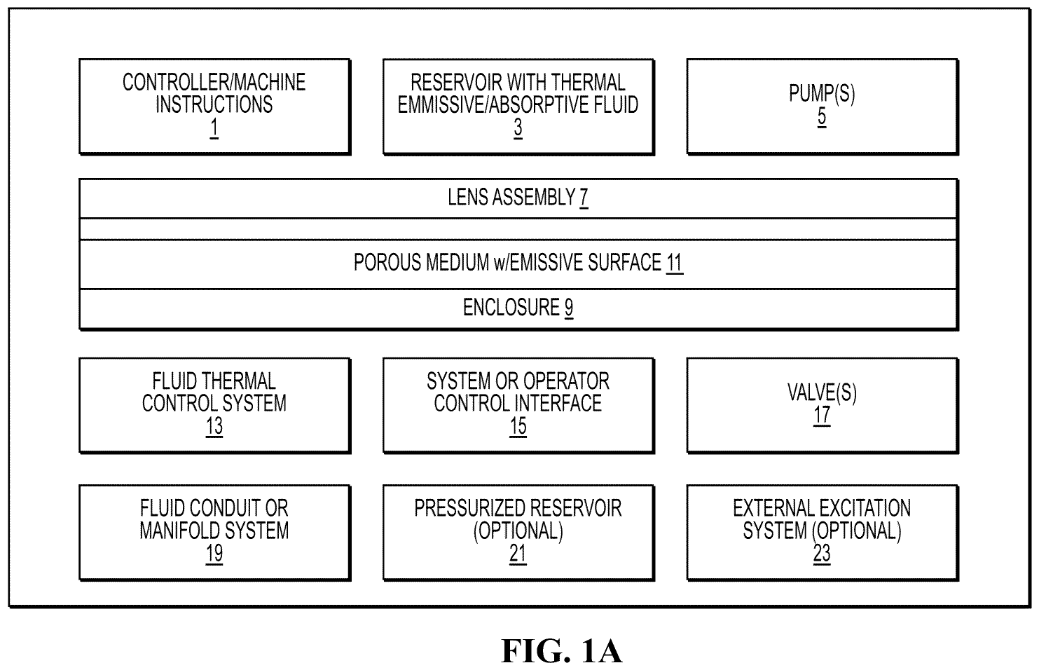

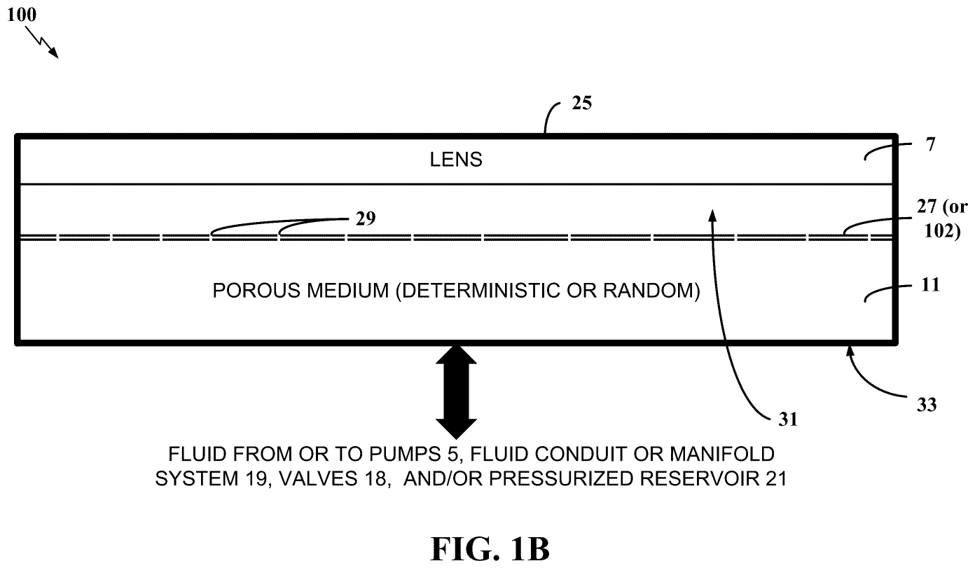

Referring to FIG. 1A, a simplified system architecture for one embodiment of the presently disclosed beacon system. In particular, an embodiment can include a controller/machine instruction system or computer 1 configured to control various elements of this embodiment including one or more fluid pumps 5, a fluid thermal control system 13, one or more valves 17, an optional external excitation system 23 that receives inputs from a system operator (e.g., via a control interface 15). An exemplary enclosure, housing, or support structure 9 is provided which has an emissive structure such as a porous medium with an emissive surface 11 positioned in relation to a lens, lens unit, or lens assembly 7 where an emissive space gap or volume is provided for between the lens assembly 7 and the porous medium 11. Valve(s) 17, fluid conduit or manifold system 19, reservoir with thermal emissive/absorptive fluid 3 are fluidly coupled with the porous medium 11 where the controller operates the pump(s) 5 and valves 17 to pass fluid from the reservoir 3 into the porous medium based on a modulation or signaling control sequence from the controller/machine instruction 1 to exude or retract fluid from the porous medium's emissive surface 11 to adjust effective surface area of the emissive surface and thereby change the surface's energy profile (e.g., thermal emissions or absorptive profile). Using this changing surface energy absorptive or emissive effect, an operator can use the present beacon system to produce a detectable energy, e.g., thermal or infrared, profile or signal sequence that can be used to communicate with an external party equipped to detect this profile or sequence.

In some aspects, it is noted that the controller or machine instructions 1 in FIG. 1A may be implemented with a microcontroller or processor. Those skilled in the art will appreciate that the controller, microcontroller, processor may further be implemented with a compact integrated circuit designed to govern a specific operation in an embedded system (e.g., an Application specific integrated circuit (ASIC)) and normally includes a processor along with a memory storing machine instructions or code implemented by the processor and inputs/outputs (I/Os). In some particular aspects, the controller 1 may be implemented using an Atmel 8-bit AVR microcontroller (or equivalents) but is not limited to such. Furthermore, it is noted that other aspects, output pins of a microcontroller or processor may be communicatively coupled to external devices such as transistors for performing switching operations implemented by the microcontroller (e.g., 1).

FIG. 1B illustrates an exemplary side view of at least a portion of a variable pressure activated porous volume emitter apparatus 100 according to certain aspects to the present disclosure. According to one particular example, the apparatus 100 includes elements of the assembly illustrated in FIG. 1A; namely lens assembly 7 and porous medium 11 and may be termed “a porous media unit” that is contained within a larger enclosure (not shown) comprising the whole of beacon system. The apparatus 100 includes an enclosure 25 to retain the various elements including the lens or lens assembly 7 and porous medium 11. It is noted that the lens 7 serves to direct and/or focus infrared energy emitted from the apparatus 100 resulting from the exuding (or retraction) of fluid from surface 27. In aspects the porous medium 11 may be implemented with an emissive surface 27 (or 102 as will be described later and also termed “a first surface disposed on a first side of the porous medium”), upon which fluid is expanded into or drawn out of the medium dependent on the cycling of the fluid. It is noted that the fluid may be water but is not limited to such. As discussed before, the porous medium 11 may be either deterministic or random/chaotic and could be implemented using porous foam (e.g., extruded polystyrene foam (XPS) such as Styrofoam®, rubber foam, urethane foam) in one example. In other examples, a metal foam may be utilized, such as aluminum or copper foam, but not necessarily limited to such metals, or ceramic foams.

Further in the example of FIG. 1A, an exemplary non-deterministic flow can be brought about by transferring a fluid through a variety of or any combination of paths between entry and exit points. A number of apertures, pores, holes, or nozzle based structures in the emissive surface 27 as shown at 29 may be used. This allows the fluid to expand into or contract from a gap or volume 31 defined between the surface 27 and a bottom portion of lens 7. Additionally, the enclosure 25 is adapted or configured to receiving fluid from or to pumps 5, fluid conduit or manifold system 19, valves 18, and/or pressurized reservoir 21 at a portion (e.g., bottom portion) of porous medium 11 as illustrated in FIG. 1B. This may also be characterized as a second surface 33 disposed on a second side of the porous medium 11 opposite the first surface of the porous medium 27 and is configured to selectively receive the fluid input to the porous medium 11 or to receive the fluid withdrawn out of the porous medium 11.

In other specific aspects, it is noted that the porous media 11 (and surface 27) my constructed of Grey Pro™ Resin and Durable™ Resin as sold by Formlabs.com, and may be additively manufactured (e.g., 3D printed) using a Stereolithography (SLA) printer. Apertures or pores (e.g., 29) may be created during the print process and quality checked prior to curing. Pore sizes are printed as designed and washed out to ensure they meet size and tolerances of design, using standard 3D SLA model processing. In still a further specific example, the pores (e.g., 29) in the media may be 0.04 inches offset at 25 degrees from normal on an orthonormal configuration and tapered down from 0.117 inches to 0.01 inches on a normal configuration. The technical term of normal used here is a pore at right angle to the abutting surface. This is just one example of a construction of the porous media disclosed herein. Other examples include laser etching, chemical etching, 3D printing, or directly machining pores into various plastics, metals, or stones with sufficient thermal mass and conductivity to meet the art prescribed in the patent. More examples include using aggregates of materials such as copper bearings to comprise the media underlying the pores on a plate. Another example is using open cell metal foams with either the pores diameters being natural to the surface of the media or the metal foam located behind a surface with pores created from the methods above. Metal ball bearings placed behind a laser etched metal surface or a 3D printed plate worked exceptionally well and is easier to make than the metal foam media variants, despite the fact that the thermal transfer was more efficient and the weight of the prototype was less in the metal foam variants. The language of a porous media is an accurate description because we took a media and either relied upon its natural porosity or added pores to existing media.

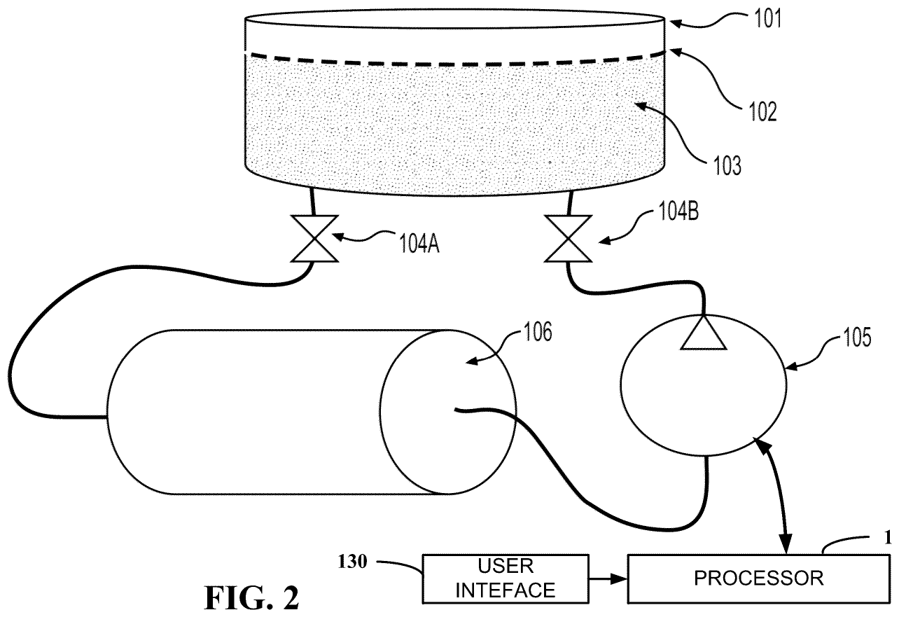

Referring to FIG. 2, another example apparatus is illustrated where an exemplary porous volume emitter (e.g., enclosure 25 in FIG. 1A) may include a transmissive lens, window or surface top 101 (which is akin to lens 7 and/or volume 31 in FIG. 1A) that serves as a physical cover of the emitter. Some embodiments can include a variety of surface area design features, variable and static topography, other typical and atypical geometrical enhancements, as well as a potential mount for polarization and or filtering optics. An emissive surface 102 (e.g., surface 27 in FIG. 1A) is provided that may be a structure from which fluid is introduced to emit infrared radiation (i.e., thermal energy). The exemplary emissive surface 102 may include a plurality of apertures (e.g., 29 in FIG. 1B) in liquid communication with a porous media 103. The plurality of apertures may vary in shape and size in order to increase or decrease surface area of droplets emitted from the emissive surface 102. In at least some embodiments fluid in the porous volume emitter may exude and retract out of emissive surface 102 due to changing pressure applied to the porous volume emitter. The fluid exuded from the plurality of apertures or pores (e.g., 29 in FIG. 1B) in the emissive surface 102 may form beads, semi-spherical shapes, droplets, etc. on the emissive surface 102 by limiting pressure acting on the fluid in the porous media so cohesive forces created by the surface tension of the fluid is greater than the external forces acting on the fluid. It is noted that those skilled in the art will appreciate that various geometries may be implemented for the apertures (e.g., 29) that engender various fluid shapes (semi-spheres, droplets, beads, etc.). Thus, in one example a plurality of beads of fluid or fluid defined by a semi-spherical surface area may be positioned on the emissive surface 102 and retracted or drawn back out by applying pressure (positive pressure for forming and negative pressure for retraction) on the fluid and then removing the pressure and even applying suction (i.e., negative pressure) on the porous structure 103 with the emissive surface 102.

Some embodiments may have a hydrophobic substance, e.g., wax, applied to surface areas surrounding pores in the emissive surface 102 which then adds to the emissive surface 102 ability to form beads or droplets and retain them in place without having the beads or droplets flow away from the pores in the emissive surface 102.

In some embodiments, the emissive surface 102 may include a drainage or fluid recovery system. The drainage or fluid recovery system may include at least one aperture (not shown) configured to collect fluid generated from the emissive surface 102. The drainage or recovery system may divert the fluid to prevent pooling of emitted liquid on the emissive surface 102. The porous media 103 may direct the fluid within the device by altering the pressure through a variety of pressure drop methods, which may include but are not limited to, nozzles, frictional forces, valves, diffusers or the like. Porous media 103 may include predetermined flow paths for the liquid such that structure enhancing thermal exchange, fluid mixing, droplet size, surface wettability, and fundamental emissivity may be easily manipulated.

Inlet and outlet valves 104A, 104B may regulate the flow of fluid into and out of the porous media 103. The valves 104A, 104B may be configured to accurately or selectively manipulate flow of fluid through the emitter by selectively increasing or decreasing fluid pressure which in turn causes fluid to exude from pores in the emissive surface 102. In an exemplary embodiment, an outlet valve 104B may be in fluid communication with the drainage or recovery system so that excess fluid may be returned from the emissive surface 102. One possible design approach of forcing fluid flow through the porous media 103 can include use of pressurization at an inlet valve 104A and relieving pressure at the outlet valve 104B. This pressurization may alter fluid flow throughout the emitter or a part of the emitter. Pressurization can also be controlled or altered to create variable, unnatural excited states in the fluid that are at the same time controllable. The exemplary fluid flow field can culminate at a surface top 101 creating an emissive source modulation event. Exemplary fluid mass flow may also be controlled to generate localized unsteady flow field that results in a varied fluid surface area in the droplets. This variable fluid surface at the emissive surface can create altered states that allow for imaging, illumination, and/or absorption that allows for relative ease in state changes and provides an efficient emissive source.

In some embodiments, valves (e.g., 104A, 104B) may be controlled by a controller operated by a user. The controller may configure the position of the values so as to generate a desired pressure in the porous volume emitter. Valves 104, 104 may also determine or produce pressure gradients, and adjust flow and amount of fluid in the porous media 103 with or without additional pressure modulation from pump.

A fluid modulation device or pump 105 may be designed or configured to selectively move fluid through the porous volume emitter in at least some embodiments. The fluid modulation device 105 may be a pump, a compressor or any suitable device configured to modulate pressure in a fluid system that includes a porous media. In some embodiments a fluid reservoir 106 may store, collect, transfer, thermally regulate, and/or filter the fluid in the porous volume emitter. In one exemplary embodiment, the fluid modulation device 105 may also include a vibration and a pressure inducing mechanism under control of processor 1 in some examples. Fluid reservoir 106 may be connected to inlet and outlet valves 104A, 104B in some embodiments. In some embodiments, fluid modulation device 105 may act in communication with input valve 104A and output valve 104B to oscillate pressure in the exemplary porous volume emitter system. The fluid modulation device 105 may oscillate pressure from a higher pressure to a lower pressure or may reverse the direction of fluid via positive or negative pressure, pushing fluid through the porous media 103 and then sucking it back toward the fluid modulation device 105. Collectively, valves 104A and 104B may be referred to herein as a “pressure regulation unit” and may be under control of the processor 1. The “fluid pressure regulation unit” (i.e., valves 104A and 104B) are in fluid communication with and disposed between the fluid pump 105 (as well as reservoir 106 in some aspects) and the second surface (e.g., 33 in FIG. 1B), and configured to regulate at least one or more of fluid flow, fluid pressure gradients, and volume of the fluid into or out of the porous medium 103.

The exemplary fluid modulation device 105 may regulate the pressure of the fluid in the porous volume emitter to keep the fluid on the emissive surface 102. In some embodiments, the fluid modulation device 105 may be held at a steady pressure or reverse the direction of the pressure after enough fluid has travelled through the porous volume emitter so that the fluid may form beads on the emissive surface 102, rather than flow out of the emissive surface 102. In other embodiments, the fluid modulation device 105 may increase pressure in the porous volume emitter so that the fluid spews or selectively sprays out of the emissive surface 102 to generated different surface area or spray patterns.

The system in FIG. 2 may also include a user interface 130. This interface affords user input to control the controller and provide user modulation inputs to control the pump.

In some embodiments, a porous volume emitter may be used as an apparent thermal source. Such a source could generate or produce different states to allow for imaging, illumination, and/or absorption. These exemplary different states can be achieved by altering a fundamental aspect to the basic physics of the energy relationship, such as changing the pressure, or, on a given emissive surface area. The exemplary porous volume emitter may alter surface area of exemplary fluid(s), and thus energy radiation, by pressure changes as the fluid is forced through the porous media 103 and formed into droplets or fluid flows or bodies which emit from emissive surface 102. The exemplary fluid temperature may not significantly change within the porous media 103 but, in some embodiments, may appear to have different temperature states when changing the emissivity to increased or decreased fluid surface area. An exemplary porous volume emitter may greatly improve the quality and speed at which the source can allow for visualization by increasing differences in fluid surface area states or speed at which the different states can be achieved through manipulation of fluid or emissive surface area by forcing the fluid through predetermined paths of the porous media 103. Exemplary alternative embodiments may have a plurality of selectively and independently controlled fluid paths or conduits (not shown) to the emissive surface which can generate individually controlled fluid emissions which each produce different emission patterns. Collectively, the fluid modulation device or pump 105, the fluid pressure regulation unit (e.g., valves 104A and 104B) and at least one processor (e.g., 1) may be referred to as “a fluid transmission system.”

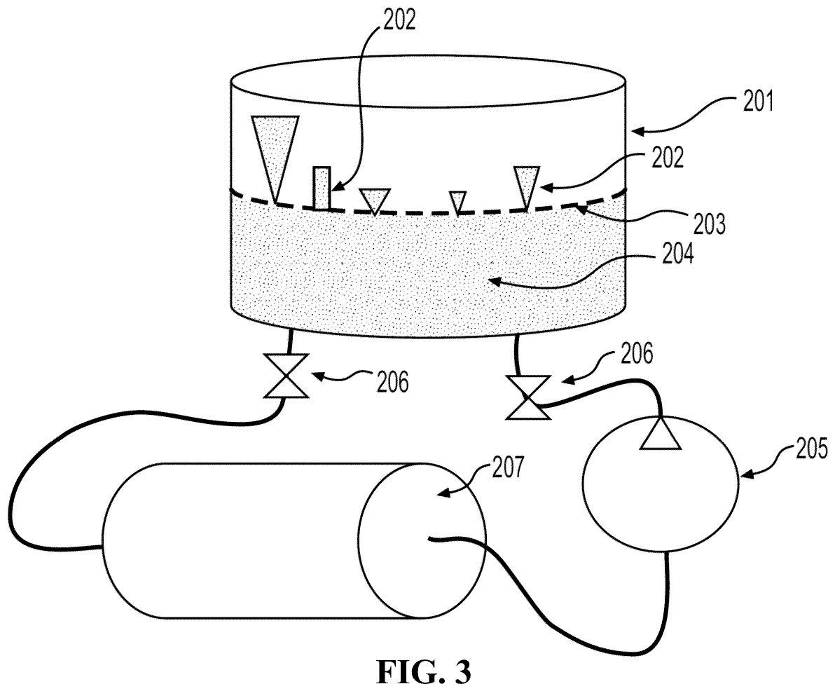

Referring to FIG. 3, an alternate embodiment of a FIG. 2 exemplary embodiment is shown which may include structures or ports 203 that emit or generate emissive plumes 202 from the port(s) 203. The emissive plumes 202 can be produced from emissive plume ports 203 that may comprise various geometric shapes designed to produce a predetermined surface area in the fluid droplets formed into different shapes including the plumes 202. Emissive plumes 202 may also comprise various spray densities to modify the apparent emissivity of the exemplary fluid.

Various alternative embodiments of the invention may also include an external excitation instrument (not shown) which may include, but is not limited to, a microwave, a radio frequency emitter, or optical wave machine or the like which is oriented towards droplets or fluid. External excitation instruments may cause agitation of the particles in the fluid in various flow fields. An alternate embodiment of the porous volume emitter may also include a pressurized tank 109 connected to the porous media 103 so that fluid may be distributed evenly upon entering the fluid paths or conduits of the porous media 103. The exemplary pump 105 may move fluid into the pressurized tank 109 until it reaches a predetermined pressure where the fluid will then move through the porous media 103 to the emissive surface 102.

An alternative embodiment can add a recovery reservoir (not shown) with an additional valve(s) coupling the recovery reservoir with various portions of a given embodiment the which selectively can recover fluid from different sections of an embodiment. For example, an embodiment can include a fluid conduit that couples a separate recovery reservoir with an emissive space between a lens and a surface of the porous media facing the lens. An embodiment can include a variant which returns recovered fluid to pressurized tank 109 via connection to a pump or back to an unpressurized reservoir which is coupled with pump

In some embodiments, a plurality of input valves 104 may be used to control the amount of fluid delivered to the porous media 103 or pressurized tank 109 from the pump 105. The plurality of input valves 104 can provide selective fluid communication between the pump 105, the fluid reservoir 106, the pressurized tank 109, and/or the porous media 103.

Alternative embodiments can include designs where pump and reservoir structures are provided in alternative configurations. For example, a pump may be disposed between or adjacent porous media 103 and reservoir 106 such that the pump can move fluid into or out of the porous media 103. In this embodiment, the pump draws fluid from the reservoir 106 and pumps 105 it into the porous media 103 when moving fluid into the porous media 103 in order to exude or extend fluid from the porous media's 103 pores and thereby increase surface area on the porous media's 103 surface and thereby alter infrared emissive or absorptive profiles of an emissive surface 102 of the porous media 103 with respect to an observer.

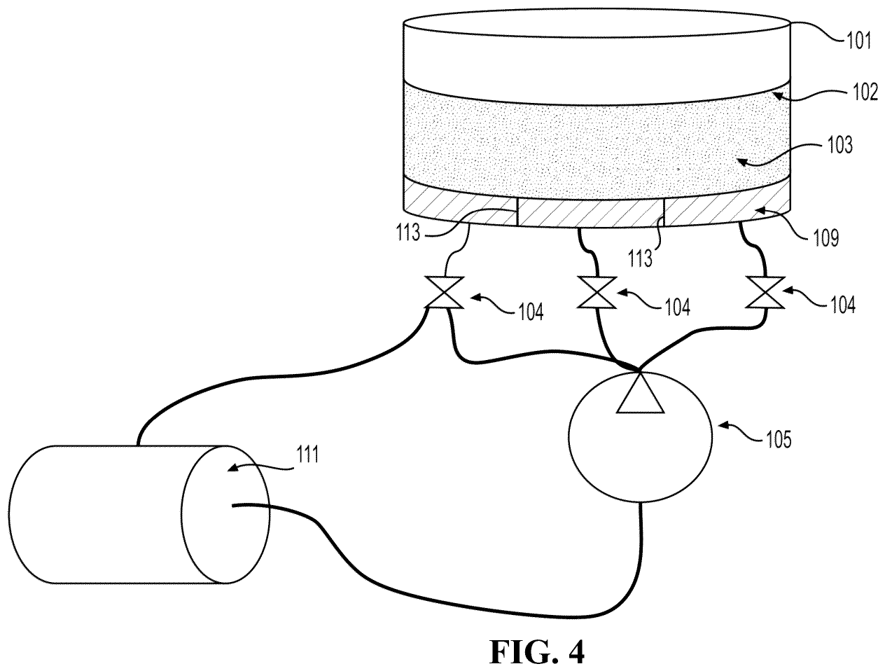

With regard to FIG. 4, another exemplary embodiment of an exemplary variable pressure activated porous emitter/beacon is shown that has multiple valves (or optionally separate pumps) that are operated to generate spatially independent flows through different flow paths allowing for localized fluid interaction or different patterns on a given emissive surface. In at least some embodiments, a separation or compartmentation of an alternative embodiment can include one based on a variant of FIG. 2 that can add an additional reservoir 111 which is coupled with the pressurized tank 109 and pump (and reservoir) 111 via added valve(s) 104 where the additional reservoir 111 is also coupled with the pump 105. Optionally, partitioned areas formed by divider structures 113 can be formed or included in pressurized tank 109 that enable or facilitate the spatially independent flows through the porous media 103 and further enable selective patterns on the porous media 103 surface. Separate fluid inputs or conduits coupled to each valve 104 can be provided to each partitioned area created by the divider structures 113. The porous media 103 can further be modified to have barriers or dividers (not shown) which further partition flow paths through the porous media 103.

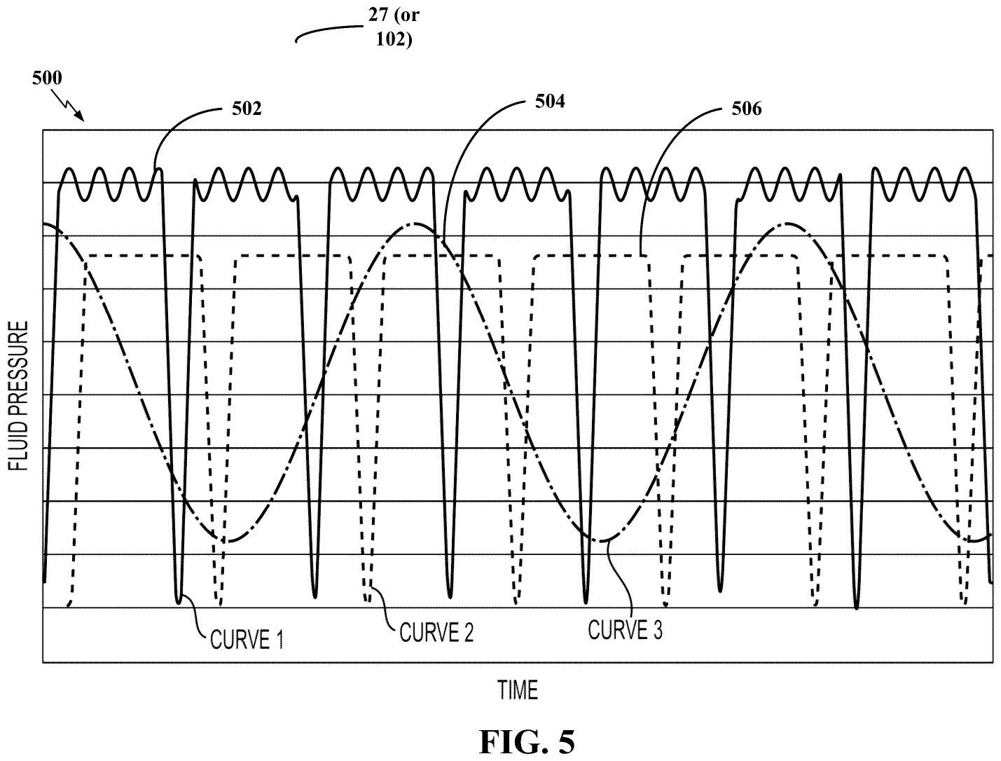

Referring to FIG. 5, three exemplary pressure curves 502, 504, and 506 are shown of pressure modulation of exemplary fluid(s) in an exemplary emittance space in relation to an exemplary porous volume emitter are shown. These exemplary altered fluid states in the exemplary emittance space may enable or provide for controllable view factors. The exemplary pressure curves can have a large variety of possible profiles that can depend or be based on a variety of design tradeoffs such as expansion method, fluid material, maximum pressure, and/or porous media 103. These exemplary curves provide examples that are associated with possible pressure changes and therefore not definitive or limiting to design space tradeoffs or choices. Although not shown, the units may be in Kpa, PSI, or any other known units of pressure.

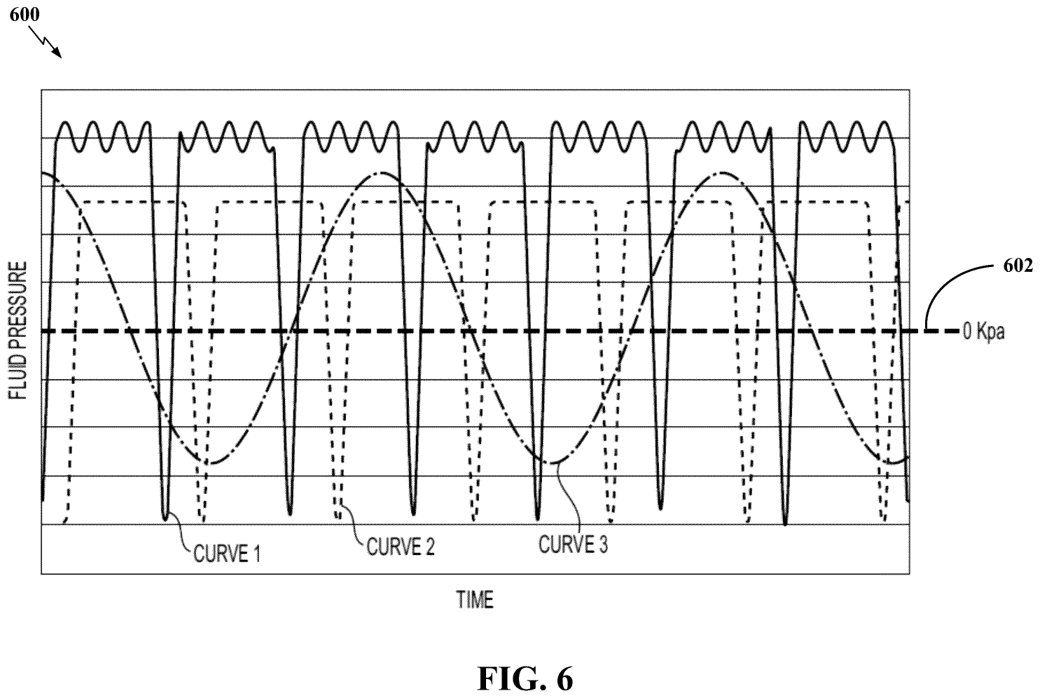

FIG. 6 shows exemplary pressure curves shown in FIG. 5, but with a zero KPa line 602 showing oscillation between positive and negative pressure. Such oscillation can be used to modulate fluid from a bead or droplet state exuded from pores in porous media 103 on emissive surface 102 (i.e., above line 602) to a retracted fluid state where beaded or droplet fluids have been sucked or withdrawn back into the pores (i.e., below line 602).

Exemplary pressure modulation of fluid emitted into the exemplary emittance space can be designed and controlled to achieve optimized surface areas by the pressure. Exemplary optimized pressure(s) can be designed based upon expansion method, fluid material, maximum pressure, and/or porous media 103 of the emittance space.

Methods of operation can include providing an exemplary embodiment of the invention, determining a pattern of modulation to generate emissions or absorption patterns from a fluid, then modulating pressure flow(s) of one or more fluid paths into a fluid emission structure based on the pattern of modulation by selectively controlling fluid pumping system(s) to generate fluid flows from the fluid emission structure.

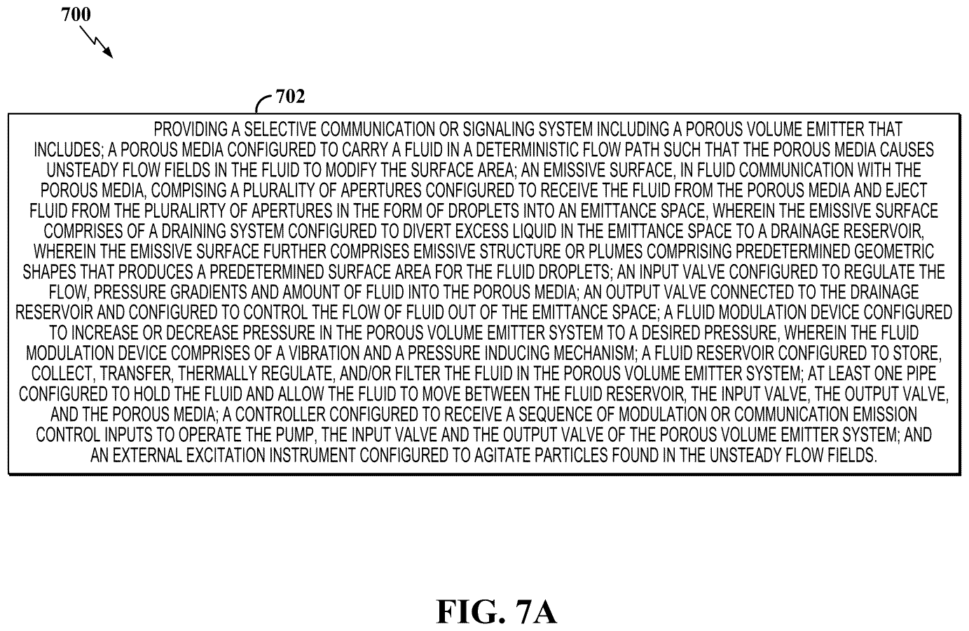

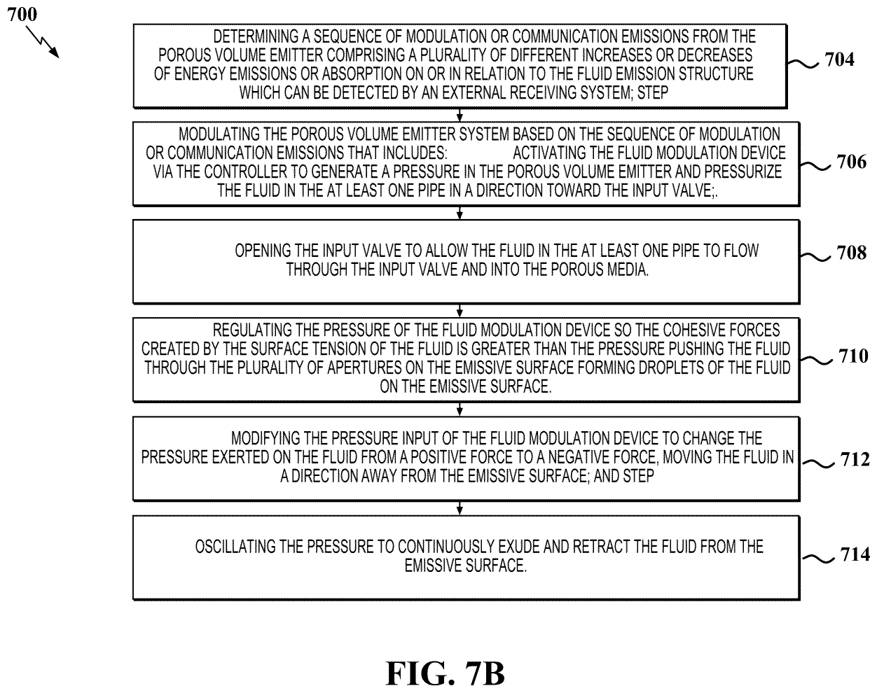

Referring to FIGS. 7A and 7B, an exemplary method 700, is shown in these figures for using a selective communication or signaling system. At block 702 in FIG. 7A, method 700 includes providing a selective communication or signaling system including a porous volume emitter that includes; a porous media configured to carry a fluid in a deterministic flow path such that the porous media causes unsteady flow fields in the fluid to modify the surface area; an emissive surface, in fluid communication with the porous media, comprising a plurality of apertures configured to receive the fluid from the porous media and eject fluid from the plurality of apertures in the form of droplets into an emittance space, wherein the emissive surface comprises of a draining system configured to divert excess liquid in the emittance space to a drainage reservoir, wherein the emissive surface further comprises emissive structure or plumes comprising predetermined geometric shapes that produces a predetermined surface area for the fluid droplets; an input valve configured to regulate the flow, pressure gradients and amount of fluid into the porous media; an output valve connected to the drainage reservoir and configured to control the flow of fluid out of the emittance space; a fluid modulation device configured to increase or decrease pressure in the porous volume emitter system to a desired pressure, wherein the fluid modulation device comprises of a vibration and a pressure inducing mechanism; a fluid reservoir configured to store, collect, transfer, thermally regulate, and/or filter the fluid in the porous volume emitter system; at least one pipe configured to hold the fluid and allow the fluid to move between the fluid reservoir, the input valve, the output valve, and the porous media; a controller configured to receive a sequence of modulation or communication emission control inputs to operate the pump, the input valve and the output valve of the porous volume emitter system; and an external excitation instrument configured to agitate particles found in the unsteady flow fields.

In FIG. 7B, method 700 further includes determining a sequence of modulation or communication emissions from the porous volume emitter comprising a plurality of different increases or decreases of energy emissions or absorption on or in relation to the fluid emission structure which can be detected by an external receiving system as shown at block 704. Further, method 700 includes modulating the porous volume emitter system based on the sequence of modulation or communication emissions that includes activating the fluid modulation device via the controller to generate a pressure in the porous volume emitter and pressurize the fluid in the at least one pipe in a direction toward the input valve as shown at block 706. Further, method 700 includes opening the input valve to allow the fluid in the at least one pipe to flow through the input valve and into the porous media as shown at block 708. Next, method 700 includes regulating the pressure of the fluid modulation device so the cohesive forces created by the surface tension of the fluid is greater than the pressure pushing the fluid through the plurality of apertures on the emissive surface forming droplets of the fluid on the emissive surface as shown at block 710. After block 710, method 700 includes modifying the pressure input of the fluid modulation device to change the pressure exerted on the fluid from a positive force to a negative force, moving the fluid in a direction away from the emissive surface as shown at block 712. Finally, method 700 includes oscillating the pressure to continuously exude and retract the fluid from the emissive surface. This exemplary method can further include providing a fluid collection system coupled with either the second surface or a gap operating the fluid collection system selectively remove said fluid from the porous media or the gap or emittance space to a drainage reservoir or returning said fluid to the fluid reservoir as shown at block 714.

Moreover, the exemplary method can further include providing a pressurized tank connected to the second side of the porous media, where the system is configured to cause the fluid to be evenly pressurized to a predetermined pressure. The exemplary method can further include an apparatus where the pressurized tank, control system, and porous media control fluid transfer to cause said fluid to be evenly pressurized to said predetermined pressure before entering the plurality of apertures or pores of the porous media.

In further aspects, it is noted that the fluid transmission systems disclosed herein may employ any number of fluid controllers and electronic fluid flow control valves (e.g., the claimed fluid pump, input valve, and output valve) for controlling flow, pressure and temperature of liquids. Specific implementations may utilize FC20 electronic proportional flow control valves manufactured by Electronic Flow Control Valve—Pneumatic Air Flow Controller (genndih.com).

Additionally, it is noted that those skilled in the art will appreciate that the control of fluid through fluid control valves also directly affects thermal control such as is utilized with the disclosed fluid reservoir including a thermal control system. In particular, thermal regulation as disclosed in the present application utilizes the principles of adiabatic process thermodynamics. Accordingly, the use of fluid control leads to thermal control in the present system.

Still further, it is noted that the selective exuding of fluid from the porous media as semi-spherical shapes, droplets, or beads form or create a second surface area (i.e., fluid area) that is greater than said first surface area as semi-spherical shapes, droplets, or beads form to create a second surface area that is greater than the first surface area due to more mass (i.e., fluid mass) being present, such as in volume 31, for example.

Although the presently disclosed apparatus and methods have been described in detail with reference to certain preferred embodiments, variations and modifications exist within the spirit and scope of the invention as described and defined in the following claims.

1. A signaling beacon comprising:
a porous media unit configured to allow a fluid to flow there through, the porous media unit including:
a porous medium configured to allow fluid to flow there through according to at least one fluid flow characteristic;
a first surface disposed on a first side of the porous medium, the first surface including a plurality of apertures therein that are configured to allow at least a portion of the fluid within the porous media to be selectively exuded onto the first surface or withdrawn from the first surface through the plurality of apertures; and
a second surface disposed on a second side of the porous medium opposite the first surface of the porous medium and configured to selectively receive the fluid input to the porous medium or to receive the fluid withdrawn out of the porous medium; and
a fluid transmission system including:
a fluid pump configured to selectively cause the fluid to be pumped into or drawn out of the porous medium via the second surface;
a fluid pressure regulation unit in fluid communication with and disposed between the fluid pump and the second surface, the fluid pressure regulation unit configured to regulate at least one or more of fluid flow, fluid pressure gradients, and volume of the fluid into or out of the porous medium; and
at least one processor configured to control operation of at least the fluid pump according to a predetermined sequence to cause the fluid to be selectively exuded onto or withdrawn from the first surface according to a predetermined modulation pattern;
wherein at least a portion of the fluid within the porous media to be selectively exuded onto the first surface or withdrawn from the first surface through the plurality of apertures.

2. The thermal signaling beacon of claim 1, further comprising:
the porous media unit including:
a lens assembly; and
a gap or volume disposed between the lens assembly and the first surface and configured to accept and contain the fluid selectively exuded onto the first surface.

3. The thermal signaling beacon of claim 1, wherein the at least one processor is configured to selectively operate the fluid pump, the input valve and the output valve to selectively exude or withdraw the fluid from the plurality of apertures based on a predetermined modulation pattern.

4. The thermal signaling beacon of claim 1, further comprising a user interface communicatively coupled to the at least one processor and is configured to receive modulation inputs to control the fluid pump.

5. The thermal signaling beacon of claim 1, further comprising a pressurized tank connected to the second side of the porous media.

6. The thermal signaling beacon of claim 1, wherein the fluid is water.

7. The thermal signaling beacon of claim 1, wherein the porous medium comprises porous foam.

8. The thermal signal beacon of claim 7, wherein the porous foam comprises one of extruded polystyrene foam (XPS), rubber foam, or urethane foam.

9. The thermal signal beacon of claim 7, wherein the porous foam comprises metal foam or ceramic foams.
